(19) United States
(12) Patent Application Publication
(10) Pub. No.: US 2015/0069813 A1
(43) Pub. Date: Mar. 12, 2015

(54) RESTRAINT HARNESS FOR A PERSON

(71) Applicant: Darrin Keith Furr, Mooresville, NC (US)

(72) Inventor: Darrin Keith Furr, Mooresville, NC (US)

(21) Appl. No.: 14/464,815

(22) Filed: Aug. 21, 2014

Related U.S. Application Data
(60) Provisional application No. 61/868,250, filed on Aug. 21, 2013.

(51) Int. Cl. B60R 21/12; B60R 22/00

(52) U.S. Cl. CPC B60R 21/12; B60R 22/00; B60R 2022/003
USPC 297/484

(57) ABSTRACT

A restraint system for restraining a prisoner or the like comprising a left belt which has a generally horizontally extending left hip belt and a generally vertically extending left shoulder strap, a right belt which has a generally horizontally extending right hip belt releasably securable to the left hip belt and a generally vertically extending right shoulder strap, and a shoulder strap spacer operable to maintain a selected spacing between the left and right shoulder straps. The free ends of the left hip belt and right hip belt and the shoulder strap spacer are adapted to be releasably attached to a fixed structure.

### FIELD OF THE INVENTION

The present invention relates to restraint systems for law enforcement or medical personnel to use for restraining violent or potentially violent persons. More particularly, the present invention relates to a restraint harness particularly well suited for use in a police cruiser to safely transport a person in custody in an upright position without impairing the person's respiratory function.

### BACKGROUND OF THE INVENTION

There is often a need for law enforcement officers to restrain individuals while they are being transported in a police cruiser or other automotive vehicle. Also, there is often a need for medical personnel to restrain violent, or potentially violent, patients. Sometimes it is necessary to restrain a person in order to protect the person from his or her self. Sometimes it is necessary to restrain a person in order to protect nearby personnel from being harmed by the person.

Handcuffs are commonly used to restrict hand and arm movements of a person. But restraint systems may be used in addition to, or instead of, handcuffs to restrain a person's torso and/or legs.

Efforts to provide restraint systems have been disclosed in several U.S. Patents, for example, U.S. Pat. No. 7,922,254 Apr. 12, 2011 to Squires et al. for SEAT SECURITY DEVICE, U.S. Pat. No. 5,651,375 Jul. 19, 1997 to James Cunningham for PRISONER IMMOBILIZATION DEVICE, and U.S. Pat. No. 4,004,583 Jan. 25, 1977 to David E. Johnson for RESTRAINING DEVICE. But there remains a need for improved restraint devices.

Of course, it is desirable that the means of restraint be effective to restrain the person while at the same time the means of restraint should not be harmful to the person being restrained. Of particular concern with respect to restraints causing harm to the person being restrained, is the potential of the restraint itself being able to contribute to respiratory failure. It is generally desirable that the restraint be able to maintain the person in an upright seated position and be unable to itself contribute to choking or other respiratory difficulties.

Another safety concern involves the consequences in a situation where the restraint must be quickly released, for example, if the vehicle has been involved in an accident and fire is imminent. An effective restraint must be designed so that the person being restrained is not able to release the restraint but the restraint should be able to be quickly released by others in the event of an emergency situation.

In order for a restraint to be useful it must be available to the officer and be able to be applied relatively quickly. Also, the restraint should be designed to restrain persons of various sizes.

In order to be available the restraint must be relatively inexpensive or few orgainizations will be able to purchase the restraint for use by their personnel. Also, it would be advantageous if the restraint were easily installed and also easily removed from the vehicle so that the vehicle can be used for other purposes without the restraint getting in the way.

Furthermore, it would be desirable if the restraint operated in association with anchor points already provided in the vehicle by the vehicle manufacturer such as the anchor points for child seats. This requirement is described in Federal Motor Vehicle Safety Standard 225 and it is an advantage of the present invention that the restraint harness is anchored to the associated vehicle by the child seat anchorages.

Accordingly, the restraint harness of the present invention is an effective, practical restraint system designed to safely protect both the person being restrained as well as others in the same vehicle.

Further understanding of the present invention will be had from the following specification and claims taken in conjunction with the accompanying drawings. As used in the following description, the terms “left” and “right” are with reference to the drawings.

### SUMMARY OF THE INVENTION

The present invention is a restraint harness or system for restraining a prisoner or the like. The restraint harness comprises a left belt which has a generally horizontally extending left hip belt and a generally vertically extending left shoulder strap, a right belt which has a generally horizontally extending right hip belt releasably securable to the left hip belt and a generally vertically extending right shoulder strap, and a shoulder strap spacer operable to maintain a selected spacing between the left and right shoulder straps. The free ends of the left hip belt and right hip belt and the shoulder strap spacer are adapted to be releasably attached to a fixed structure such as the child seat anchor points of an automobile. The belts and straps are flexible but substantially inelastic so as to be effective in use as means for restraint restraining movement of a person.

### BRIEF DESCRIPTION OF THE DRAWINGS

FIG. 1 is a perspective view, with portions broken away, showing a preferred embodiment of a restraint harness of the present invention in use restraining a person in custody in a rear seat of a police car;

FIG. 2 is a plan view showing the preferred embodiment of FIG. 1;

FIG. 3 is a perspective view, with portions broken away, showing an alternative preferred embodiment of a restraint harness of the present invention in use restraining a person in a front seat of a police car;

FIG. 4 is a plan view showing the alternate preferred embodiment of FIG. 3;

FIG. 5 is a perspective view of a quick release latch lever device suitable for use in either of the preferred embodiments of the present invention;

FIG. 6 is a perspective view of a quick release receiver suitable for use with the quick release latch lever of FIG. 4; and

FIG. 7 is a releasable latch suitable for use to anchor the ends of straps and belts of either of the preferred embodiments of the present invention to fixed anchor points in a vehicle or the like.

### DESCRIPTION OF THE INVENTION

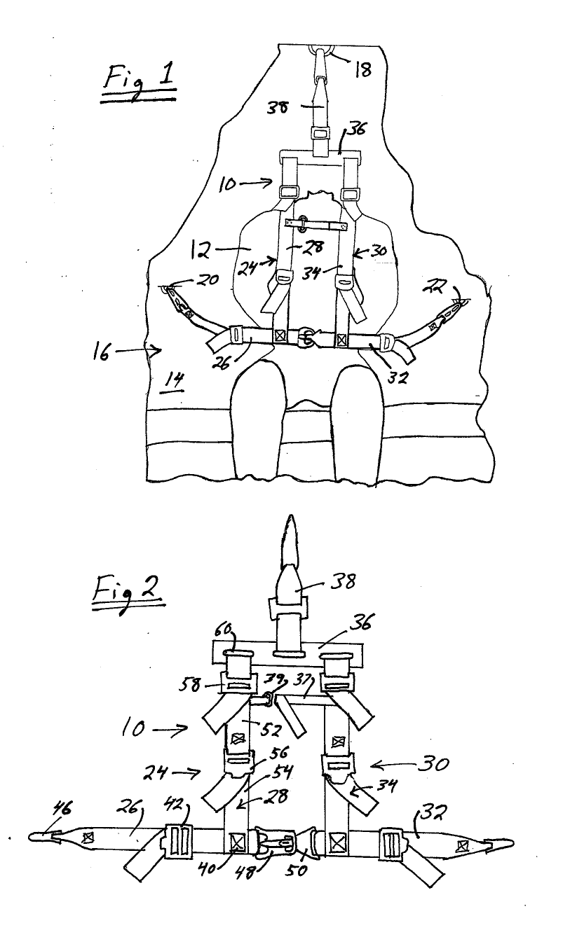

Now referring to FIG. 1, a preferred embodiment of a restraint harness of the present invention is shown and indicated generally by the numeral 10. In FIG. 1 restraint harness 10 is shown in use to restrain prisoner 12 in the backseat 14 of police cruiser 16 behind a conventional police cruise partition (not shown in the Figure). Police lo cruisers are generally of conventional U.S. automotive manufacture and hence are equipped with child seat anchorages. The present invention takes advantage of the conventional child seat anchorages which provide points of securement for restraint harness 10. Restraint harness 10 is anchored to cruiser 16 at child seat anchor points 18, 20, and 22 of the vehicle. Child seat anchor points are not intended for use to provide crash protection for adults. Hence, it is intended that restraint harness 10 will be used in addition to, and not in replacement of, a conventional seat belt (not shown in the figures). It will be appreciated by those skilled in the art that prisoner restraint harness 10 is particularly well adapted for use in a backseat of a police vehicle and that child seat anchor points are sufficiently strong for use to anchor restraint harness 10 for its use to restain movement of an adult person's torso. It will also be appreciated by those skilled in the art that restraint of a person's torso in the Back seat of a typical police cruiser will also effectively restrain the person's legs from kicking since there is minimal “leg room” in the back seat of a typical police cruiser because of the location of the partition. Of course, should restraint harness 10 be anchored differently and found to meet the safety regulations for crash restraint means, such use is within the broad scope of the present invention.

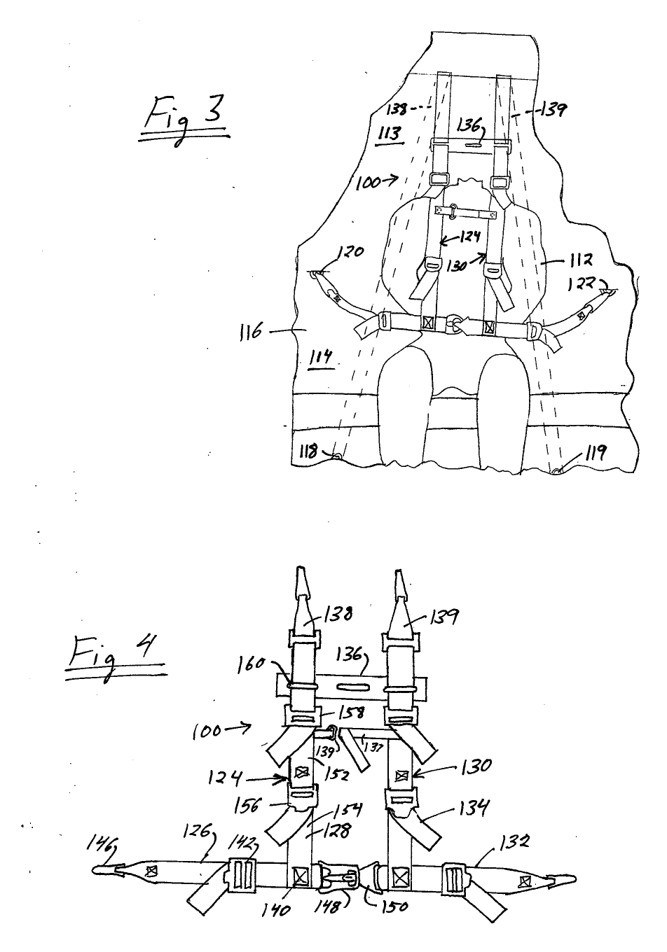

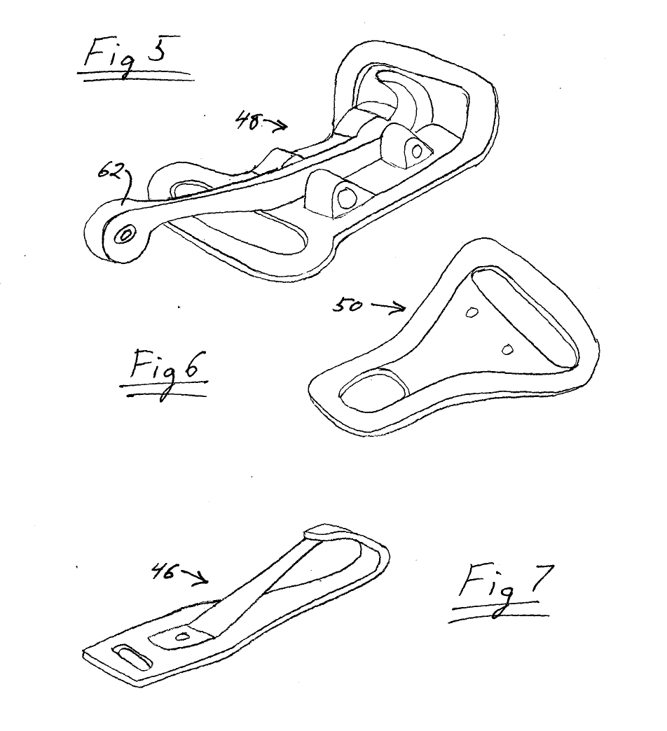

As is best shown in FIG. 3, restraint harness 10 generally comprises:

(A) left belt 24 which has a generally horizontally extending left hip belt 26 and a generally vertically extending left shoulder strap 28;

(B) right belt 30 which has a generally horizontally extending right hip belt 32 quick releasably secured to left hip belt 26 and a generally vertically extending right shoulder strap 34;

(C) shoulder strap spacer 36 attached to and spacing left shoulder strap 28 and right shoulder strap 34; and

(D) shoulder strap spacer tether 38 adjustably attached to shoulder strap spacer 36.

Left belt 24 comprises a generally horizontally extending left hip belt 26 and a generally vertically extending left shoulder strap 28 which belt and strap are flexible but substantially inelastic. Belt 26 and strap 28 can be made, for example, of 1¾ inch wide polyester webbing or the like such as is suitable for conventional or racing automotive seat belts. Left hip belt 26 and left shoulder strap 28 are sewn together by stitching 40. Left hip belt 26 is inserted through conventional three bar adjuster 42 to provide means for adjusting its length. The left end of hip belt 26 is attached to anchor latch 46 which is adapted to releasably clip or attach to a conventional child seat anchor ring of an automotive vehicle. The right end of hip belt 26 is attached to a quick release latch member 48 which cooperates with quick release latch member 50 attached to the left end of right hip belt 32.

Generally vertically extending shoulder strap 28 is secured to left lap belt 26 by stitching 40 and is disposed at about a right angle thereto. Left shoulder strap 28 is of two piece construction, having an upper piece 52 and a lower piece 54 with ends inserted through self-tightening adjuster 56 and three bar adjuster 58. Upper piece 52 of shoulder strap 28 is looped through aperture 60 in the left side of shoulder webbing spacer 32. A two piece cross strap 37 is provided with metal ring 39 and hook and loop fastener means to maintain spacing between left shoulder strap 28 and right shoulder strap 34 in conjunction with shoulder webbing spacer 32. While illustrated as a two piece construction, shoulder strap 28 may alternatively be of one piece construction.

Right belt 30 has a construction analogous to left belt 24 but is the mirror image thereof and has quick release latch member 50 which cooperates with quick release latch member 48 of left hip belt 26.

Restraint harness 10 is designed to safely limit the mobility of a person, such as a prisoner, during his or her transport in a vehicle, such as a police cruiser, by securing the person's hips and shoulders, keeping him or her in an upright position. Restraint harness 10 uses a three anchor point system that anchors to all cars having child safety seat anchors. It is intended for use in conjunction with a conventional seat belt provided in the vehicle and which meets DOT standards for seat belts. Restraint harness 10 can be constructed of racing grade safety webbing and hardware or, less preferably, of consumer grade safety webbing and hardware. No tools are required for installation or removal of harness 10 from the vehicle. A person can be quickly secured in harness 10 and removal of his or her securement requires only the pull of lever 62 (which may have a strap attached to facilitate this procedure) of latch 48. Proper use of harness 10 can reduce likelihood of officer or prisoner injury or destruction of property.

Now referring to FIGS. 3 and 4, an alternative preferred embodiment of a restraint harness is shown and indicated generally by the numeral 100. FIG. 3 illustrates restraint harness 100 in use to restrain prisoner 112 in front seat 114 of police vehicle 116. It will be appreciated by those skilled in the art that child seat anchor points are not provided in the front seats of automobiles so restraint harness 100 differs from restraint harness 10 previously described in that restraint harness 100 is designed to be anchored by fixed anchor points which must be added to the vehicle by an installer. Thus, restraint harness 100 is anchored by anchor points 118, 119, 120, and 122 which have been installed in vehicle 116 and which can be secured to seat belt anchors, seat anchors or other securements welded to the vehicle.

As is best shown in FIG. 3, restraint harness 100 generally comprises:

(A) left belt 124 which has a generally horizontally extending left hip belt 126 and a generally vertically extending left shoulder strap 128;

(B) right belt 130 which has a generally horizontally extending right hip belt 132 releasably secured to left hip belt 126 and a generally vertically extending right shoulder strap 134;

(C) shoulder strap spacer 136 attached to and spacing left shoulder strap 128 and right shoulder strap 134; and

(D) shoulder strap spacer tethers 138 and 139 extending over the back of seat 114 and adjustably attached to shoulder strap spacer 136.

Left belt 124 comprises a generally horizontally extending left hip belt 126 and a generally vertically extending left shoulder strap 128 which are analogous to left hip belt 26 and left shoulder strap 28. Thus, left hip belt 126 and left should strap 128 can be made of 1¾ A inch wide flexible but inelastic polyester webbing or the like such as is suitable for automotive seat belts. Left hip belt 126 is inserted through a conventional three bar adjuster 142 to provide means for adjusting its length. One end of hip belt 126 is attached to anchor latch 146 which is adapted to releasably clip or attach to a conventional child seat anchor ring of an automotive vehicle. The other end of hip belt 126 is attached to a quick release latch member 148 which cooperates with quick release latch member 150 attached to right hip belt 132.

Generally vertically extending shoulder strap 128 is secured to left lap belt 126 by stitching 140 and is disposed at a right angle thereto. Left shoulder strap 128 is of two piece construction, having an upper piece 152 and a lower piece 154 with ends inserted through self tightening adjuster 156 and three bar adjuster 158. Upper piece 152 of shoulder strap 128 is looped through aperture 160 in the left side of shoulder strap spacer 136. A two piece cross strap 137 is provided with metal ring 139 and hook and loop fastener means to maintain spacing between left shoulder strap 128 and right shoulder strap 134 in conjunction with shoulder webbing spacer 32. While illustrated as a two piece construction, shoulder strap 128 may alternatively be of one piece construction.

Shoulder strap spacer 136 is secured to anchor points 118 and 119 by tether straps 138 and 139 which extend over the seatback 113 of seat 114. Anchor points 118 and 119 are preferably simply eyebolts or the like attached to seat bolts of seat 114.

Right belt 130 has a construction analogous to left belt 124 but is the mirror image thereof and has quick release latch member 150 which cooperates with quick release latch member 148 of left hip belt 126.

Restraint harness 100 is designed to safely limit the mobility of a person, such as a prisoner, during his or her transport in the front seat of a vehicle, such as a police cruiser, by securing the person's hips and shoulders, keeping him or her in an upright position. Restraint harness 100 uses a four anchor point system that can anchors to seat belt attachment points and seat bolts. Restraint harness 110 is intended for use in conjunction with a conventional seat belt provided in the vehicle so that DOT certification is not required for restraint harness 100. However, restraint harness 10 can be constructed of webbing and hardware suitable to meet DOT requirements if desired. No tools are required for installation or removal of harness 10 from the vehicle. A person can be quickly secured in harness 10 and removal of his or her securement requires only the pull of a single strap. Proper use of harness 10 can reduce likelihood of officer or prisoner injury or destruction of property.

While preferred embodiments of the present invention have been disclosed in the foregoing disclosure, the present invention is subject to variation and modification within the broad scope of the invention. Therefore, it will be appreciated by those skilled in the art that the present invention is intended to be limited only by the scope of the following claims.

What is claimed is:

1. A restraint harness for restraining a person has:
(A) left belt 24 which has a generally horizontally extending left hip belt 26 and a generally vertically extending left shoulder strap 28;
(B) right belt 30 which has a generally horizontally extending right hip belt 32 releasably secured to left hip belt 26 and a generally vertically extending right shoulder strap 34;
(C) shoulder strap spacer 36 attached to and spacing left shoulder strap 28 and right shoulder strap 34; and
(D) shoulder strap spacer tether 38 adjustably attached to shoulder strap spacer 36.
